(19) United States
(12) Patent Application Publication
(10) Pub. No.: US 2005/0182715 A1
(43) Pub. Date: Aug. 18, 2005

(54) Method and system for charging for repeated use of a digital content item

(76) Inventor: Hideaki Kawahara, Portland, OR (US)

Correspondence Address: Hideaki Kawahara, Suite 310, 900 SW St. Clair Ave., Portland, OR, 97205, US

(21) Appl. No.: 11/051,236

(22) Filed: Feb. 4, 2005

Related U.S. Application Data
(60) Provisional application No. 60/545,257, filed on Feb. 17, 2004.

(51) Int. Cl. G06F 17/60

(52) U.S. Cl. 705/39

(57) ABSTRACT

A method and system for charging a customer for repeated use of a digital content item. The system charges the customer for each use of the item until the total charge for the item reaches a predetermined charge limit. Once the total charge has reached the charge limit, the system grants the customer unlimited use of the item and waives further charges to the customer.

### BACKGROUND OF THE INVENTION

The advent of the Internet, combined with the recent development of data compression technology, enabled us to deliver digital contents, such as music, movies, still pictures, and books, over the network.

Currently, the most prominent development of the field is online music services. Most of the services currently available are roughly categorized into three classes. The first one is music downloading services, such as iTunes Music Service and Napster 2.0. They are Internet versions of record stores. The second one is on-demand streaming subscription services, such as Rhapsody. The third one is pay-as-you-go on-demand streaming services, such as SonicSelector. Those services are often offered combined along with Internet radio stations.

A downloading services charges a customer an up front fee for an unlimited usage right for a music track or a set of tracks. While this is a very familiar concept to customers, it inherits the same problems of the traditional media, such as CDs. Namely:
(a) A customer have to pay the same amount even if the customer plays it back only a few times;
(b) Often, the customer must make a purchase decision prior to listen to the entire track.

An on-demand streaming subscription service usually charges a flat fee for a period of time regardless of the amount of the usage. This is a relatively new marketing model and has a number of unresolved issues, such as:
(a) While some customers would benefit from it, it is not economical for customers who use it infrequently;
(b) Unless the service has all the music the customer wants, the customer needs to subscribe to more than one service;
(c) The above problem will make customers to choose services upon the quantity of the music the services have, rather than the quality. This would encourage artists to produce more music possibly with less quality, and could stifle their creativity;
(d) Once the market is saturated, the only ways to increase the revenue for a service provider is either to increase the fee, or to divide its music library and charge customers separately for each sub-library. Neither of them would be very popular to customers;
(e) Since it requires a verification of a subscription, there will be technical difficulties for use with multiple devices, especially with portable devices;
(f) Many customers still prefer to “own” unlimited usage rights to music tracks. If a customer stops subscribing to the service, the customer will be left with no music collection of his or her own.

A pay-as-you-go on-demand streaming service charges a small fee for each playback of a music track. There is no need to charge a subscription fee and its pricing scheme is more “fair.” But it still has problems similar to those of subscription services. Namely;
(a) The pricing is not competitive to downloading services for music tracks the customer plays back numerous times;
(b) Since the service needs to add a charge every time a music track is played back, there will be technical difficulties for devices not connected to a network, especially portable devices;
(c) As in subscription services, many customers still prefer to “own” unlimited usage rights to music tracks.

### BRIEF SUMMARY OF THE INVENTION

An embodiment of the present invention provides a method and system for charging a customer a usage charge for each use of a digital content item, and for granting the customer unlimited use of the item when the total charge for the item to the customer reached a predetermined charge limit for the item.

### BRIEF DESCRIPTION OF THE DRAWINGS

FIG. 1 shows an embodiment with optional components and signals in dashed lines.

FIG. 2 shows a flow chart of a single playback.

### DETAILED DESCRIPTION OF THE INVENTION

### 1. Minimal Embodiment

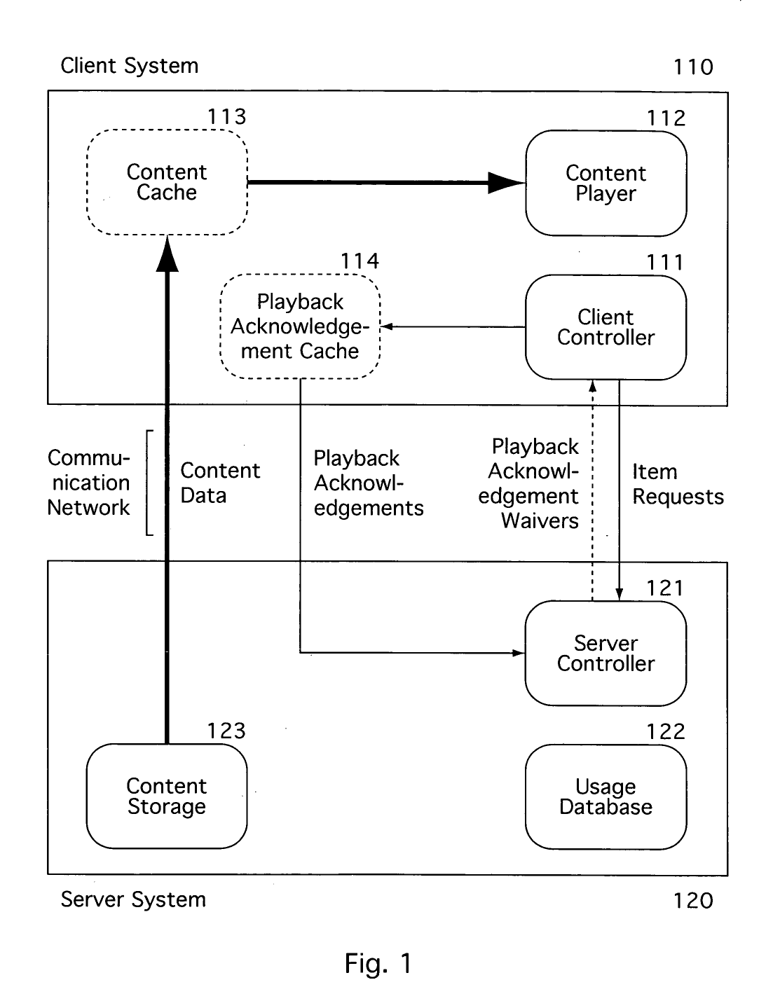

FIG. 1 shows a minimal embodiment of the system, along with optional components and signals drawn in dashed lines. The optional components and signals are described later in this section. All data and signals bypass the optional components in this minimal embodiment.

The system consists of a client system 110, a server system 120 and a communication network. The communication network carries the content data and all control signals between the client and server systems shown in the figure. Most of the signal paths within each sub-system are implicit and not shown in the figure for simplicity.

Client system 110 comprises:
(a) a client system controller 111 which controls the client system and communicates with server system 120 upon customer's requests, and
(b) a content player 112 which plays back content items.

Server system 120 comprises:
(a) a server system controller 121 which controls the server system and communicates with client system 110,
(b) a usage database 122 which stores total charges for items played back by the customer, and
(c) a content storage 123 which stores the content items the service provides.

A client system can be implemented in a personal computer, a TV set-top box, an Internet appliance, a cellular phone, a portable music player, etc. Typically, a server system serves more than one client system, and comprises of a server computer or a cluster of server computers with a mass storage device as the content storage. The communication network can be the Internet, a wireless phone network, a satellite network, etc.

### 2. Operation

For each content item, the service provider sets a charge limit, which should be competitive to the purchase price from downloading services, and a usage charge, which should be a small fraction of the charge limit.

The customer must have an account at the service provider. Before starting content playbacks, the client system establishes a connection to the server system and identifies the customer.

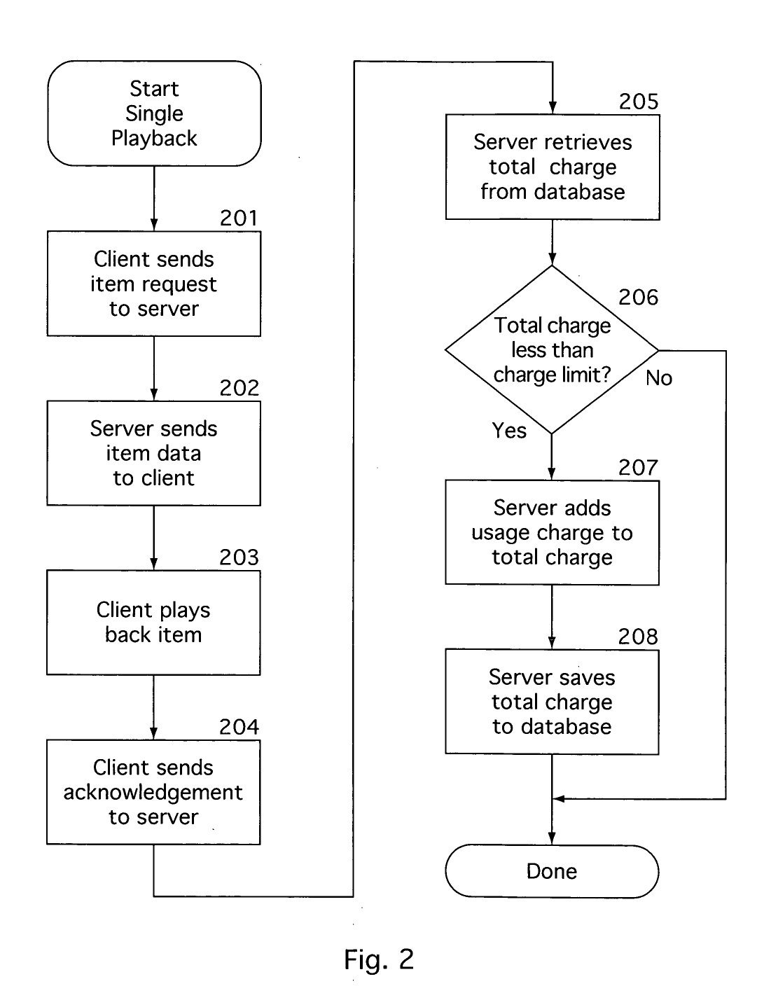

FIG. 2 is a flow chart of the operation for a single playback of a content item:
(1) In step 201, upon the customer's request, the client controller sends an item request to the server;
(2) In step 202, the server system retrieves the content data for the item from the content storage and sends it to the client system;
(3) In step 203, the content player plays back the item.
(4) In step 204, the client controller sends a playback acknowledgement to the server system during or after the playback;
(5) In step 205, upon receiving the playback acknowledgement, the server controller retrieves the total charge for the item to the customer;
(6) In step 206, the server controller compares the total charge to the charge limit for the item;
(7) In step 207, if and only if the total charge is less than the charge limit for the item, the server controller adds the usage charge to the total charge;
(8) In step 208, the server controller saves the total charge to the database if the total charge was increased.

### 3. Optional Components

Optional components are also shown in FIG. 1 drawn in dashed lines:
(a) A content cache 113 in client system 110 which stores some of the items recently used by the client system;
(b) A playback acknowledgement cache 114 in client system 110 which delays sending playback acknowledgements to the server system for a certain period and/or amount.

### 4. Alternative Operations

There are various alternative operations to offer a more attractive pricing structure, to reduce the load to the system, and to improve the usability:
(a) The service provider may prorate the usage charge if the item was not played back in its entirety. To support this feature, the client system may send multiple playback acknowledgments in certain intervals, instead of a single acknowledgement in step 204 in FIG. 2;
(b) The service provider may set a charge limit to a set of items, such as a music album, not to individual items in the set. The usage charge for the item will be added to the total charge of the set only if the total charge is less than the charge limit for the set;
(c) The service provider may set both charge limits for a set and each item in the set. In this case, the total charge for the set is the sum of all total charges for the items in the set. Both total charges will be compared against their corresponding charge limits to see if the usage charge should be added to the total charge for the item in step 206 in FIG. 2;
(d) If the client system implements content cache 113 in FIG. 1 and the item requested by the customer is in the cache, the client system may omit sending an item request and receiving the content data to reduce the load to the server and the network;
(e) The server system may choose to send a “waiver” of playback acknowledgements for an item to the client system, once the total charge for the item reached the charge limit. After receiving the waiver, the client system can omit sending playback acknowledgements for the item in step 204 in FIG. 2. If the client system implements content cache 113 and the item is in the cache, the client system does not need to use the communication network.
(f) Upon receiving the waiver described above, the client system may convert the content data of the item into a data file in a common format, so that the customer can play it back on a non-proprietary devices without having to connect to the communication network.
(g) If the client system implements acknowledgement cache 114 in FIG. 1, the client system may choose to delay sending playback acknowledgements up to a certain duration and/or a certain amount in certain circumstances, such as unavailability of the communication network. If the client system also implements content cache 113 and the item is in the cache, the client system does not need to use the network.

### 5. CONCLUSIONS, RAMIFICATIONS AND SCOPE

From the description above, the advantages of the present invention become evident:
(a) A customer can play back a digital content item at a small charge. The customer does not need to make a purchase decision before evaluating the item in its entirety;
(b) The total charge to an item will not exceed its charge limit. Once the total charge reached the charge limit, it is equivalent to a “purchase” in the traditional sense. Therefore, it is competitive to the traditional outlets and online download services. It also gives customers a sense of “ownership”;
(c) Once the charge limit is met, it is technically easier to allow the customer to use the item on a non-proprietary device with or without a network connection since there will be no further charges for the item;
(d) As a customer accumulates total charges for items, those items can be seen as “partially purchased.” This would give the customer a sense of building his or her own library at the service provider, and create the customer's loyalty to the provider;
(e) Since no fixed fees, such as subscription fee and sign-up fee, are necessary, it is very easy for a service provider to acquire customers;
(f) Since a customer can subscribe to multiple services with no extra cost as long as service providers do not charge any fixed fees, the size of the content library a service provider offers is less of an issue. A service provider can be small and independent, and still profitable;
(g) Since a customer can try out an item at a small charge, a less known content creator will have a better chance to succeed;
(h) Since a lesser quality item will be used less often, there will be a clear relation between the quality of the contents and the revenue. This would make content creators to focus on the quality of the contents.

The present invention would be ideal for a wide range of customers as well as service providers. Customers will be charged as they use the service while building their own content collections. For service providers, it is easy to let customers to sign-up for their services. The sizes of their content libraries are not as crucial as their quality. This should encourage content creators to produce better contents, rather than to produce more.

Although the description above contains many specificities, those should not be constructed as limiting the scope of the invention, but as merely providing illustration of some of the presently preferred embodiments of this invention. For example, a content item can be a movie, a still picture, a book, a video game or computer software.

Thus the scope of the present invention should be determined not by the embodiments illustrated, but by the appended claims and their legal equivalents.

1. A method for charging a customer for use of a digital content item comprising:
(a) providing a predetermined usage charge for said item,
(b) providing a predetermined charge limit for said item,
(c) providing a client system comprising a content player,
(d) providing a server system comprising a storage for said item and a database for the total charge for said item to said customer,
(e) providing a communication network between said client system and said server system,
(f) said client system sending a request for said item to said server system over said communication network,
(g) in response to said request, said server system sending said item to said client system over said communication network,
(h) said client system playing back said item,
(i) said client system sending an acknowledgement or a plurality of acknowledgements of the playback to said server system over said communication network,
(j) in response to said acknowledgment or acknowledgements, said server system adding said usage charge to said total charge if said total charge is less than said charge limit,
whereby said total charge initially increases incrementally for each use, while said total charge is limited to said charge limit.

2. The method of claim 1 wherein said item is a music track.

3. The method of claim 1 wherein said item is a set of a plurality of music tracks.

4. The method of claim 1 wherein said item is a movie.

5. The method of claim 1 wherein said item is a book.

6. The method of claim 1 wherein said usage charge is prorated if the entirety of said item was not played back.

7. The method of claim 1 further comprising:
(a) providing a set of a plurality of digital content items that includes said item,
(b) providing a second predetermined charge limit for said set,
(c) in response to said acknowledgement or acknowledgements, said server system adding said usage charge to said total charge only if said total charge of said item is less than said charge limit for said item, and the sum of all total charges for the items in said set is also less than said second charge limit,
whereby said sum is also limited by said second charge limit.

8. A system for charging a customer for use of a digital content item comprising:
(a) a communication network which carries said item and a plurality of communication signals, including a request for said item and an acknowledgement or a plurality of acknowledgements of a playback of said item,
(b) a client system which sends out said request for said item, receives and plays back said item, and sends out said acknowledgement or acknowledgements,
(c) a server system which stores the total charge for said item to said customer, stores and sends out said item, and adds a predetermined usage charge for said item to said total charge upon receiving said acknowledgement or acknowledgements if said total charge is less than a predetermined charge limit for said item,
whereby said total charge initially increases incrementally for each use, while said total charge is limited to said charge limit.

9. The system of claim 8 further comprising a content cache in said client system, whereby said client system can omit sending said request and receiving said item if said item is in said content cache to reduce the load to said communication network and said server system.

10. The system of claim 9 further comprising an acknowledgement cache in said client system to delay sending said acknowledgement or acknowledgements to said server, whereby said client system can play back said item even when the communication network is unavailable if said item is in said content cache.

11. The system of claim 8 wherein said server system sends said client system a waiver of acknowledgments for playbacks of said item upon said total charge reaching said charge limit.

12. The system of claim 11 further comprising means for converting said item to a data file in a common format in said client system upon receiving said waiver, whereby said customer can play back said item on a non-proprietary content player.

13. The system of claim 8 wherein said communication network is the Internet.

14. The system of claim 8 wherein said communication network is a wireless phone network.

15. The system of claim 8 wherein said server system is implemented in a server computer or a system comprising a plurality of server computers.

16. The system of claim 8 wherein said client system is implemented in a personal computer.

17. The system of claim 8 wherein said client system is implemented in a television set-top box.

18. The system of claim 8 wherein said client system is implemented in an Internet appliance.

19. The system of claim 8 wherein said client system is implemented in a cellular phone.

20. The system of claim 8 wherein said client system is implemented in a portable music player.
